(19) United States
(12) Patent Application Publication
(10) Pub. No.: US 2019/0001660 A1
(43) Pub. Date: Jan. 3, 2019

(54) PROCESS FOR PRINTING INK TO PROVIDE HIGH OPACITY SUBSTRATE

(71) Applicant: The Procter & Gamble Company, Cincinnati, OH (US)

(72) Inventors: Christian KOHLWEYER, Bad Vilbel (DE); Thorsten BLUM, Zschorlau (DE); Paul Edmund BAKER, Silchester (GB)

(21) Appl. No.: 16/015,485

(22) Filed: Jun. 22, 2018

(30) Foreign Application Priority Data
Jul. 3, 2017 (EP) 17179248.4

(51) Int. Cl. B41F 3/54; B41F 3/02; B41F 5/24

(52) U.S. Cl. CPC B41F 3/54; B41F 5/24; B41F 3/02

(57) ABSTRACT

The present invention relates to a process for flexographic printing of ink onto a thin polymeric film substrate. In particular the process relates to printing using a central impression cylinder press, wherein the width of printed substrate is greater than 800 mm, to provide a high opacity printing process. According to the present invention the printing process comprising:
transferring ink from an ink reservoir to an anilox roll;
transferring the ink from the anilox roll to a printing plate wherein the ink volume transferred by the anilox roll is from 9-20 cm³/m²; and
   applying the ink to the surface of the substrate by applying pressure between the printing plate and an impression surface and passing the substrate between the printing plate and the impression surface wherein the printing plate is a high definition printing plate comprising at least 40 lines per centimeter.

### FIELD OF THE INVENTION

The present invention relates to a process for printing of ink onto a polymeric film substrate. The process provides a high opacity printed substrate.

### BACKGROUND OF THE INVENTION

Consumer products are typically packaged by the product manufacturer and shipped in packaged form through a distribution network to the consumers. In many cases consumers make their choice about which products to buy based, at least in part, on the information communicated by, and the overall impression given by, the package appearance.

Certain consumer products, such as absorbent hygiene articles, are packaged and presented to consumers in a printed plastic film which is folded and sealed so as to contain the products. These products are thus protected from contamination as they pass through the distribution network into the hands of the consumers. Printed graphics and text on the package convey to the consumer information about the product.

Manufacturers are seeking to use thinner plastic films for packaging partly in response to demands for ever more lightweight packaging which has the advantage of improved environmental sustainability profile. Another advantage of lightweight packaging is lower packaging material costs.

A disadvantage of thin plastic films for packaging is that reduced thickness leads to reduced opacity of the film. The point may be reached where the plastic film is so thin that the product within the package is at least partly visible from the outside. This undesirable effect may be exacerbated when the plastic film is white or a pale or pastel colour and when the packaged products within the package are themselves decorated with bright, vivid colours. In this case the colours of the product or the outline of the products may be visible through the thin packaging film.

EP-1 857 290, published on Nov. 21, 2007, discloses opaque printed substrates that can be made with clear or low opacity films. Metallic ink is used in the preparation of the opaque printed substrate.

There remains a need for opaque printed substrates which mask the outline and the colours of the products which are contained within a package which is made from the opaque printed substrate even when the printed substrate comprises a thin polymeric film, for example of thickness of 100 micrometers or less.

### SUMMARY OF THE INVENTION

The present invention relates to a process for flexographic printing of ink onto a thin polymeric film substrate. In particular the process relates to printing using a central impression cylinder press, wherein the width of printed substrate is greater than 800 mm, to provide a high opacity printing process. According to the present invention the printing process comprising:
transferring ink from an ink reservoir to an anilox roll;
transferring the ink from the anilox roll to a printing plate wherein the ink volume transferred by the anilox roll is from 9-20 cm³/m²; and
applying the ink to the surface of the substrate by applying pressure between the printing plate and an impression surface and passing the substrate between the printing plate and the impression surface wherein the printing plate is a high definition printing plate comprising at least 40 lines per centimeter.

The thickness of the polymeric film substrate is from 12-100 micrometers, preferably from 35-70 micrometers.

### BRIEF DESCRIPTION OF THE DRAWINGS

FIG. 1 shows a schematic of a flexographic printing system.

FIG. 2 shows in more detail a part of FIG. 1.

### DETAILED DESCRIPTION OF THE INVENTION

### Definitions

“Flexography” is a form of printing that uses flexible rubber relief plates. It is commonly used in package printing.

“Anilox” is an engraved metal or ceramic roller used in flexographic printing presses to transfer ink from the fountain roller (or directly from the fountain) to the printing plate. A flexographic inking system is sometimes known as an anilox system. The purpose of the anilox roller is to pick up ink from the fountain roller (or, in some configurations, directly from the ink fountain) and deliver a predetermined, metered, uniform amount of ink to the rubber printing plate.

“Plate Cylinder” is the part of the flexographic press to which the rubber or photopolymer plate is attached. The flexo plate cylinder can be removed and swapped with cylinders of varying diameters, depending upon the application. The plate is inked by the adjacent anilox roller, and transfers the raised images directly to the web of substrate passing between the plate cylinder and the impression cylinder.

A central impression press is a type of printing press used in multi-color flexography in which a single large-diameter common impression cylinder supports the substrate as it contacts a series of adjacent plate cylinders, which lay down successive colors to the left or right dependent on the web feed direction. Central impression presses can have at least two printing units, with six to ten being the most common.

The opaque printed substrate typically serves as a “blank canvas” onto which coloured inks are then printed in order to create the final package comprising printed graphics, text etc. The process according to the present invention provides an opaque printed substrate which is particularly suitable for receiving coloured inks subsequently printed thereon. Without wishing to be bound by theory, it is believed that the dry opaque printed substrate, preferably white printed substrate, has a relatively high surface roughness which provides a desirable matte effect. Moreover the high opacity printed substrate helps to reduce or avoid undesirable interaction between the coloured graphics on the outside of the package and the coloured products which are partly visible from within the package. This helps to maintain the bright and vibrant appearance of the package graphics and avoids a dull appearance that may otherwise be caused by the coloured products lying behind the coloured graphics.

From finger printing tests, it was observed that printing the coloured inks onto the opaque printed substrate results in an improved ink lay-down with no pinholes in solid areas, smooth print outs of vignettes with no ink bridging, cleaner print which helps deliver sharper printed dots in highlight areas and a wider colour gamut.

Inks are solvent-based inks which typically comprise, pigment, resin, solvent and additives.

White inks may use titanium dioxide, zinc oxide, lithopone or zinc sulfide as white pigment. Titanium dioxide is preferred as white pigment. Titanium dioxide exists in three different crystalline forms, rutile, anatase and brookite. The rutile and anatase forms have the highest refractive index of all white pigments, and provide the highest coverage for ink coatings. Rutile has the greatest opacity, and anatase has the greatest whiteness. The anatase form is most preferred. Pigments are typically subject to modification by grinding and/or surface treatment, for example. Grinding may modify surface area, with higher surface areas generally preferred.

Resins may comprise nitrocellulose, preferably in combination with polyurethane or polyacrylate.

Solvents may comprise ethanol or isopropyl alcohol, or combinations thereof. Preferred solvents are mixtures of ethanol or isopropyl alcohol, or combinations thereof, with an acetate such as ethyl acetate or n-propyl acetate. Other solvents include various glycol ethers.

Various additives may be added to the ink composition, such as wax.

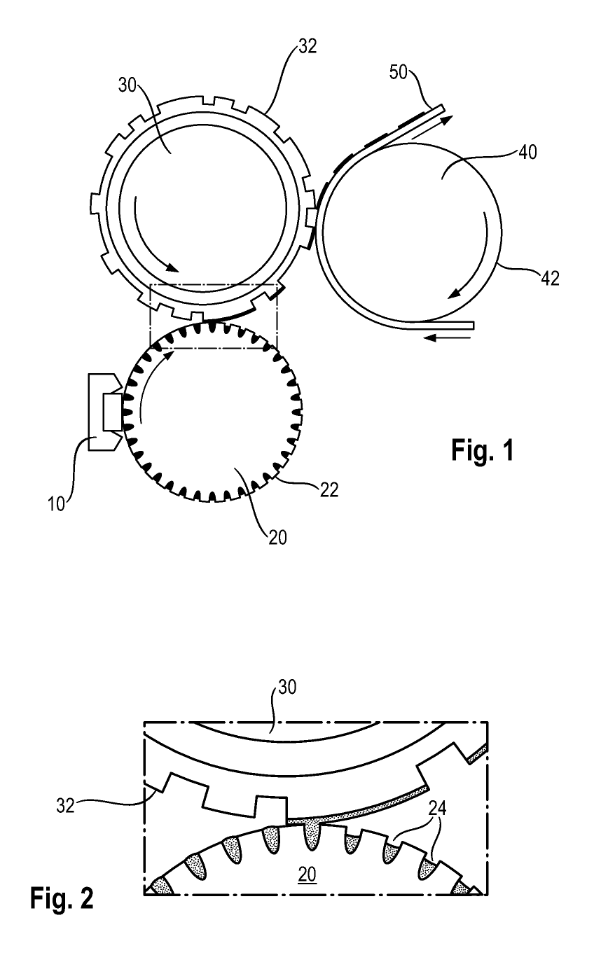

FIG. 1 shows a schematic of a flexographic printing system comprising ink supply (10), anilox roller (20), print cylinder (30) and impression cylinder (40).

The ink supply (10) may be a chambered doctor blade system, preferably comprising a hard doctor blade and set to a doctor blade chamber pressure of from 1 to 4 bar.

The anilox roller (20) serves to meter the volume of ink which is applied. Preferably, the outer surface (22) of the anilox roller comprises an array of cavities or “cells” (24) arranged from 100-250 lines per centimeter. The cells may be hexagonal in shape. Alternatively anilox rollers may also be used which do not comprise discrete cells such as High Volume Solids, Tri-Helical, Fluid, Open Channel and Open Slalom Ink Channel anilox engraved geometries.

Printing plate (32) is disposed around the plate cylinder (30). Preferably the printing plate is a high definition printing plate comprising either an array of dots which are flat top dots or an array of dots which are round top dots with microcell structures.

Impression surface (42) is disposed around the impression cylinder (40).

Polymeric film substrate (50) is passed between the printing plate (32) and the impression surface (42). Pressure is applied between the printing plate and the impression surface. Preferably the applied pressure is from 80-220 N/m². Preferably the speed at which the substrate is passed between the printing roll and the impression roll is from 100-600, preferably from 150-300 meters/minute.

The polymeric film substrate preferably comprises low density polyethylene, high density polyethylene, Polypropylene, bi-orientated Polypropylene, other combinations of polyolefins, polyethylene terephthalate (polyesters), metallised polyesters and nylon.

The polymeric film substrate may be either a pigmented film or a clear film.

The quality of the package impression may be further improved by printing with high resolution graphics. Preferably graphic images should be created and maintained in high resolution. For example photographic images may be captured and stored using at least 50 megaPixels. Preferably the high resolution images are maintained in master data files so as to minimize degradation of image quality over time through repeated digital manipulation.

### EXAMPLES

| | White Ink | White Ink |
|---|---|---|
| | Reference | High Opacity |
| Pigment | Titanium dioxide | Titanium dioxide |
| Resin | Nitrocellulose/ | Nitrocellulose/ |
| | Polyurethane | Polyacrylate |
| Solvent | Ethanol/Propylene | Ethanol/Ethyl |
| | Glycol Ether, | Acetate, |
| | ratio 3:1 | ratio 4:1 |

A pigmented film substrate having a starting opacity of 80% was subjected to a flexographic printing process as set out above applying high opacity white ink comprising titanium dioxide, nitrocellulose, polyacrylate, ethanol and ethyl acetate. The opacity was increased to 92%.

Opacity was measured using an X-Rite advance spectrophotometer according to ISO 6504-03.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for flexographic printing of ink onto a polymeric film substrate in a central impression cylinder press, wherein the width of printed substrate is greater than 800 mm, to provide high opacity printing, the printing process comprising:
transferring ink from an ink reservoir to an anilox roll;
transferring the ink from the anilox roll to a printing plate; and
applying the ink to the surface of the substrate by applying pressure between the printing plate and an impression surface and passing the substrate between the printing plate and the impression surface;
wherein the thickness of the polymeric film substrate is from about 12 to about 100 micrometers and characterized in that the ink volume transferred by the anilox roll is from about 9-about 20 cm³/m², and the printing plate is a high definition printing plate comprising at least about 40 lines per centimeter.

2. The process according to claim 1 wherein the high definition printing plate comprises an array of dots which are flat top dots.

3. The process according to claim 1 wherein the high definition printing plate comprises an array of dots which are round top dots with microcell structures.

4. The process according to claim 1 wherein the anilox roll comprises lines of cells between about 100 and about 250 lines per centimeter.

5. The process according to claim 1 wherein the speed at which the substrate is passed between the printing roll and the impression roll is from about 100-about 500 meters/minute.

6. The process according to claim 5 wherein the speed at which the substrate is passed between the printing roll and the impression roll is from about 150-about 300 metres/minute.

7. The process according to claim 1 wherein the print pressure applied between the printing roll and the impression roll is from about 80-about 220 N/m².

8. The process according to claim 1 wherein the ink comprises pigment, resin and solvent, and wherein the pigment comprises titanium dioxide.

9. The process according to claim 8 wherein the solvent comprises ethanol or isopropyl alcohol, or mixtures thereof.

10. The process according to claim 9 wherein the solvent further comprises an acetate.

11. The process according to claim 10 wherein the acetate is selected from ethyl acetate or n-propyl acetate or mixtures thereof.

12. The process according to of claim 9 wherein the solvent further comprises glycol ether.

13. The process according to claim 8 wherein the resin comprises nitrocellulose.

14. The process according to claim 13 wherein the resin further comprises polyurethane or polyacrylate, or mixtures thereof.

15. The process according to claim 1 wherein the opacity of the polymeric film substrate before the printing process, measured according to ISO 6504-03, is less than about 80% and the opacity of the printed film substrate after printing of the white ink is greater than about 90%, measured according to ISO 6504-03.

16. The process according to claim 14 wherein the opacity of the printed film substrate after printing of the white ink is greater than about 92%, measured according to ISO 6504-03.
